(19) United States
(12) Patent Application Publication
(10) Pub. No.: US 2014/0316700 A1
(43) Pub. Date: Oct. 23, 2014

(54) Systems and Methods for Path Finding

(71) Applicant: Tencent Technology (Shenzhen) Company Limited, Shenzhen (CN)

(72) Inventors: Runzong Zheng, Shenzhen (CN); Jun Guo, Shenzhen (CN)

(73) Assignee: Tencent Technology (Shenzhen) Company Limited, Shenzhen (CN)

(21) Appl. No.: 14/217,563

(22) Filed: Mar. 18, 2014

Related U.S. Application Data
(63) Continuation of application No. PCT/CN2013/087819, filed on Nov. 25, 2013.

(30) Foreign Application Priority Data
Apr. 22, 2013 (CN) 201310140681.7

(51) Int. Cl. G01C 21/34

(52) U.S. Cl. CPC G01C 21/3446
USPC 701/533

(57) ABSTRACT

Systems and methods are provided for path finding. For example, a first path of a first object and a second path of a second object are calculated during a predetermined time period; one or more first interpolating points are set at one or more first times associated with the first path and one or more second interpolating points are set at one or more second times associated with the second path; one or more first barrier-value levels are set for the one or more first interpolating points based on at least information associated with a first precedence related to the first interpolating points; one or more second barrier-value levels are set for the one or more second interpolating points based on at least information associated with a second precedence related to the second interpolating points.

### CROSS-REFERENCES TO RELATED APPLICATIONS

This application claims priority to Chinese Patent Application No. 201310140681.7, filed Apr. 22, 2013, incorporated by reference herein for all purposes.

### BACKGROUND OF THE INVENTION

Certain embodiments of the present invention are directed to computer technology. More particularly, some embodiments of the invention provide systems and methods for path finding. Merely by way of example, some embodiments of the invention have been applied to maps. But it would be recognized that the invention has a much broader range of applicability.

A path-finding process includes: selecting a position as a target position and an object as a start position, and finding a path from the start position to the target position. Currently, relatively mature path-finding algorithms include: an A* (A-star) path-finding algorithm, a Dijkstra algorithm, etc.

In reality, an object has its size and different objects cannot overlap or pass through each other. Thus, an object can be blocked in a moving process in a particular space. In computer applications, the target position and the start position are often placed on a figure, and the figure is usually divided into a number of nodes (e.g., generally small squares) to simplify certain calculations.

FIG. 1 is a simplified diagram showing movements of a two-dimensional object. A large square zone is divided into multiple small squares with a same size. There are three movable objects A, B and C, and a fixed object filled with slant lines. Assuming the object A corresponds to the target position, the objects B and C need to move close to the object A. As shown in FIG. 1, the size of object A is 2×2, the size of object B is 1×1 and the size of object C is 4×4. If a straight line from object B to object A is used as a path, there is a problem that the fixed object becomes a barrier. Researches based on physics and mathematical models can provide solutions to such a problem.

Computer calculations of a path are often periodic. For example, the calculations are carried out with a tick (e.g., a time period) as the period. FIG. 2A and FIG. 2B are simplified diagrams showing movements of an object. FIG. 2A shows a position of object B at time T0, and FIG. 2B shows another position of object B at time T1. The arrow indicates the moving direction. Barrier data of a particular object are needed for a barrier. Usually, in a map including multiple nodes, a barrier value of a node is represented by a half of char type (e.g., four bits). The barrier value of a current position of an object on the map is set and cleared before and after each tick. For example, the difference between T0 and T1 is equal to a tick. If the object B moves a node within a tick, the node occupied by the object B is set with a barrier value.

The above-noted movement approach with barriers is a common solution which works well when the amount of data to be processed is small and a tick corresponds to a short time period. But when the amount of data to be processed is large, intervals between ticks associated with a background program are often too long, so as to cause crossing problems, i.e., mutual pass-through. FIG. 3 is a simplified diagram showing mutual pass-through of objects B and D. The arrow represents a moving direction.

To solve the barrier problem, interpolation detection is introduced. FIG. 4A is a simplified diagram showing movement of an object without interpolating values, and FIG. 4B is a simplified diagram showing movement of an object with interpolating values. As shown in FIG. 4A, there is no interpolation, and the part filled with slanted lines corresponds to a static barrier. If a tick is too long, object B passes through the barrier, which is unreasonable. As shown in FIG. 4B, interpolation detection is performed. That is, an interpolating point is inserted on the moving path of the object B. Thus, it is detected that the object B collides with the barrier. For each time corresponding to an interpolating point, the position of the object is determined and a barrier value is set at the position.

But after the interpolating points are added, multiple barriers are set at different positions on a path of the object during a tick, which often causes the object occupies barriers with a much larger size than the size of the object. In reality, a long distance usually appear between different objects, if a larger number of objects exist. FIG. 5 is a simplified diagram showing movement of an object with interpolating points. If four interpolating points T0-T3 are added during a tick, barrier values are set at T0 for four nodes on the path of object B. At T1, the object B has left the first barrier, but the barrier value of the node corresponding to the first barrier is not reset until after a complete tick. Thus, when another object D begins path-finding movements, the object D has to wait or find another path. This may often result in unreasonably large distance between different objects, and a realistic simulation of object movements cannot be achieved.

Hence it is highly desirable to improve the techniques for path finding.

### BRIEF SUMMARY OF THE INVENTION

According to one embodiment, a method is provided for path finding. For example, a first path of a first object and a second path of a second object are calculated during a predetermined time period; one or more first interpolating points are set at one or more first times associated with the first path and one or more second interpolating points are set at one or more second times associated with the second path; one or more first barrier-value levels are set for the one or more first interpolating points based on at least information associated with a first precedence related to the first interpolating points; one or more second barrier-value levels are set for the one or more second interpolating points based on at least information associated with a second precedence related to the second interpolating points; and in response to the first path overlapping with the second path in an overlap zone and the first barrier-value levels of the first object being higher than the second barrier-value levels of the second object in the overlap zone, a third path of the second object is recalculated in the overlap zone and after the overlap zone.

According to another embodiment, a device for path finding includes: an initial-calculation unit, a setting unit, a judging unit, and a barrier-value-calculation unit. The initial-calculation unit is configured to calculate a first path of a first object and a second path of a second object during a predetermined time period. The setting unit is configured to set one or more first interpolating points at one or more first times associated with the first path and one or more second interpolating points at one or more second times associated with the second path, set one or more first barrier-value levels for the one or more first interpolating points based on at least information associated with a first precedence related to the first interpolating points, and set one or more second barrier-value levels for the one or more second interpolating points based on at least information associated with a second precedence related to the second interpolating points. The judging unit is configured to determine whether the first path overlaps with the second path and determine, in response to the first path overlapping with the second path in an overlap zone, whether the first barrier-value levels of the first object are higher than the second barrier-value levels of the second object in the overlap zone. The barrier-value-calculation unit is configured to, in response to the first path overlapping with the second path in an overlap zone and the first barrier-value levels of the first object being higher than the second barrier-value levels of the second object in the overlap zone, recalculate a third path of the second object in the overlap zone and after the overlap zone.

According to yet another embodiment, a non-transitory computer readable storage medium comprises programming instructions for path finding. The programming instructions are configured to cause one or more data processors to execute certain operations. For example, a first path of a first object and a second path of a second object are calculated during a predetermined time period; one or more first interpolating points are set at one or more first times associated with the first path and one or more second interpolating points are set at one or more second times associated with the second path; one or more first barrier-value levels are set for the one or more first interpolating points based on at least information associated with a first precedence related to the first interpolating points; one or more second barrier-value levels are set for the one or more second interpolating points based on at least information associated with a second precedence related to the second interpolating points; and in response to the first path overlapping with the second path in an overlap zone and the first barrier-value levels of the first object being higher than the second barrier-value levels of the second object in the overlap zone, a third path of the second object is recalculated in the overlap zone and after the overlap zone.

For example, the systems and methods described herein are configured to set interpolating points according to different times during a predetermined time period and set different barrier values corresponding to the interpolating points in order to solve problems related to long intervals between ticks.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing movements of a two-dimensional object.

FIG. 2A and FIG. 2B are simplified diagrams showing movements of an object.

FIG. 3 is a simplified diagram showing mutual pass-through of objects.

FIG. 4A is a simplified diagram showing movement of an object without interpolating values, and FIG. 4B is a simplified diagram showing movement of an object with interpolating values.

FIG. 5 is a simplified diagram showing movement of an object with interpolating points.

FIG. 6 is a simplified diagram showing a method for path finding according to one embodiment of the present invention.

FIG. 7 is a simplified diagram showing different barrier-value levels for different interpolating points according to one embodiment of the present invention.

FIG. 8 is a simplified diagram showing a method for path finding according to one embodiment of the present invention.

FIG. 9 is a simplified diagram showing a method using an edge-path-finding algorithm according to one embodiment of the present invention.

FIG. 10 is a simplified diagram showing different searching directions of a process as shown in FIG. 9 according to one embodiment of the present invention.

FIG. 11 is a simplified diagram showing direction detection according to one embodiment of the present invention.

FIGS. 12-14 are simplified diagrams showing certain error corrections in path finding according to some embodiments of the present invention.

FIG. 15 is a simplified diagram showing a device for path finding according to one embodiment of the present invention.

FIG. 16 is a simplified diagram showing a terminal for path finding according to one embodiment of the present invention.

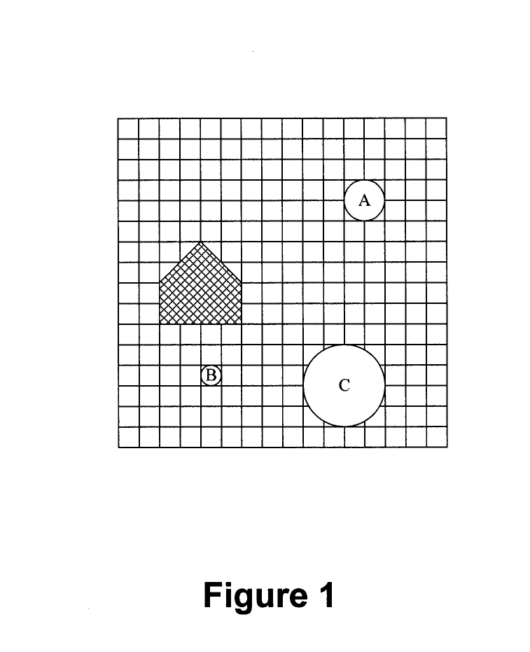

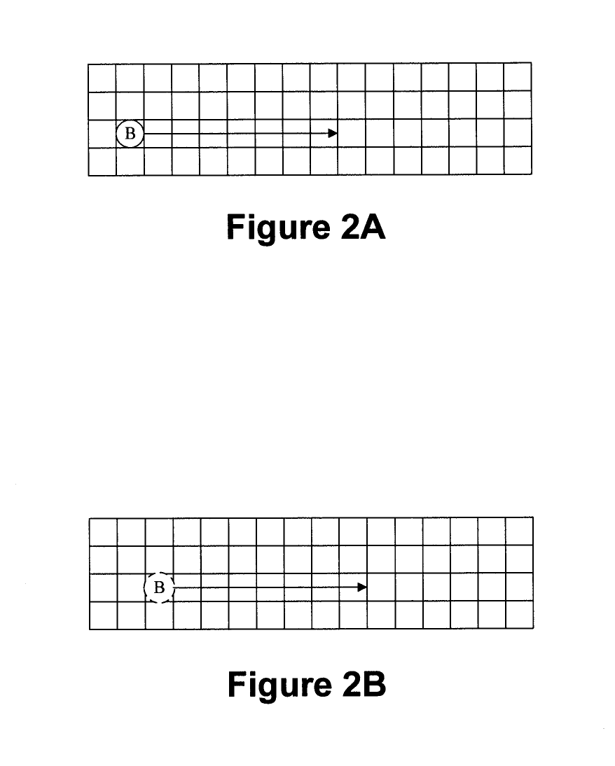

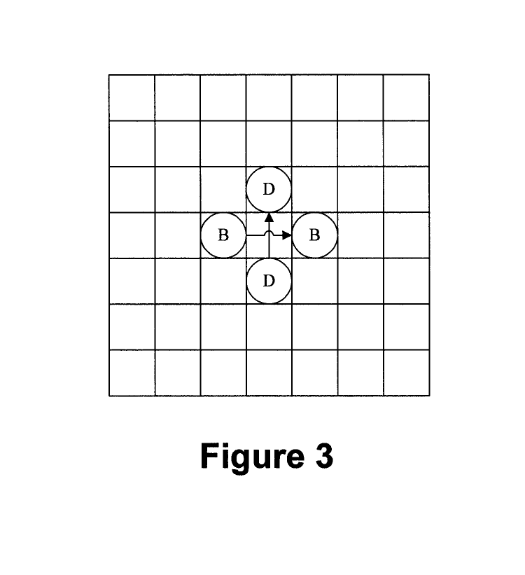

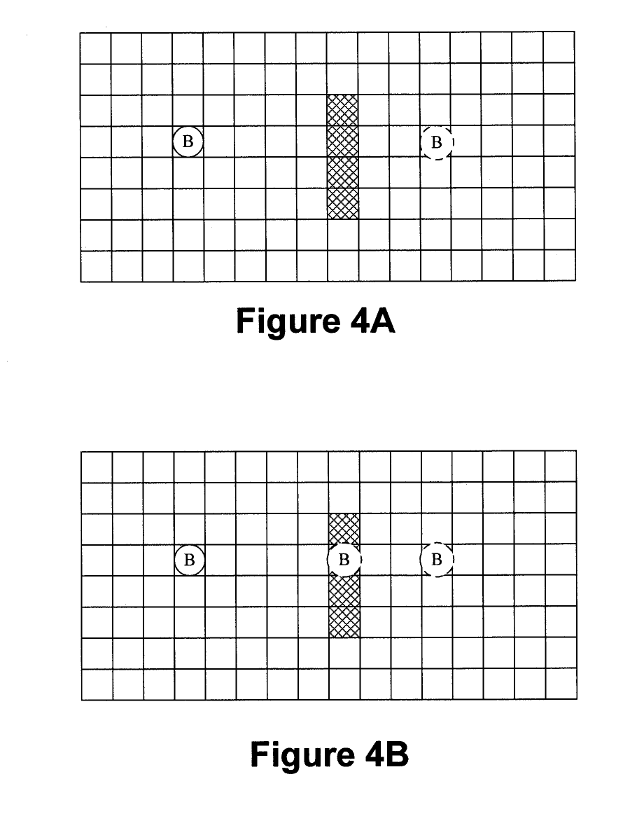

### DETAILED DESCRIPTION OF THE INVENTION

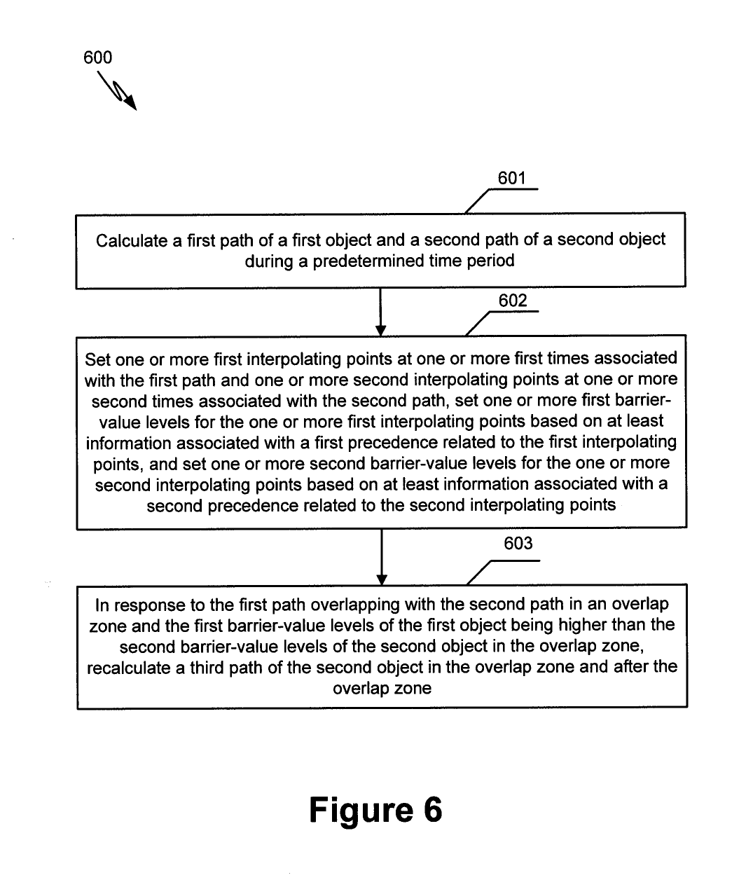

FIG. 6 is a simplified diagram showing a method for path finding according to one embodiment of the present invention. This diagram is merely an example, which should not unduly limit the scope of the claims. One of ordinary skill in the art would recognize many variations, alternatives, and modifications. The method 600 includes at least the processes 601-603.

According to one embodiment, the process 601 includes: calculating a first path of a first object and a second path of a second object during a predetermined time period. For example, any path-finding algorithms can be used to calculate the paths related to the first object and the second object in the predetermined time period. The “first” and “second” are only used for distinguish two objects without any other restrictions. The method 600 is applied to multiple objects, in some embodiments. For example, one object may block multiple other objects.

According to another embodiment, the calculating a first path of a first object and a second path of a second object during a predetermined time period includes: calculating the first path and the second path using a linear-path-finding algorithm; in response to failure of calculating the first path and the second path using the linear-path-finding algorithm or a first distance to a target position from the first object or the second object exceeding a predetermined value, calculating the first path and the second path using a footprint-path-finding algorithm; in response to failure of calculating the first path and the second path using the footprint-path-finding algorithm, calculating the first path and the second path using an edge-path-finding algorithm. For example, the calculating a first path of a first object and a second path of a second object during a predetermined time period further includes: in response to failure of calculating the first path and the second path using the edge-path-finding algorithm, performing encirclement detection and direction detection; in response to an encirclement being formed or a second distance being larger than a predetermined failure value, calculating the first path and the second path using an A* path-finding algorithm; and in response to the encirclement not being formed or the second distance being not larger than a predetermined failure value, performing edge-encirclement path-finding.

According to yet another embodiment, the method 600 further includes calculating a path if the target is encircled. For example, in response to failure of calculating the first path of the first object and the second path of the second object during the predetermined time period, a third path is chosen as the first path or the second path from one or more failed paths calculated using an A* path-finding algorithm for the first object or the second object during the predetermined time period, the third path being shortest among the failed paths.

In one embodiment, the method 600 includes calculating the path if an object is blocked by a static barrier. For example, in response to failure of calculating the first path of the first object and the second path of the second object during the predetermined time period, whether the first object or the second object overlaps with a static barrier is determined. As an example, in response to the first object overlapping with the static barrier, a first size of the first object is set to a minimum calculable size, and in response to the second object overlapping with the static barrier, a second size of the second object is set to the minimum calculable size.

In another embodiment, the method 600 includes calculating the path when an object with a higher priority among multiple objects is blocked. For example, in response to failure of calculating the first path of the first object and the second path of the second object during the predetermined time period, a first priority of the first object and a second priority of the second object are determined. As an example, in response to the first priority being higher than the second priority and the first object being blocked by the second object, the second barrier-value levels are ignored, and in response to the second priority being higher than the first priority and the second object being blocked by the first object, the first barrier-value levels are ignored.

In yet another embodiment, the method 600 makes movements of an object with a higher priority more intelligent. For example, the method 600 further includes: determining a first priority of the first object and a second priority of the second object; in response to the first priority being higher than the second priority, increasing a third priority of the first object for calculating the first path; and in response to the second priority being higher than the first priority, increasing a fourth priority of the second object for calculating the second path. In another example, the method 600 is applied to online network games. In some strategic fight scenes (e.g., in Elite BOSS War), a searching depth of path finding is increased for a particular monster and a priority of the monster associated with the tick is improved so that the monster has more fighting skills.

According to one embodiment, the process 602 includes: setting one or more first interpolating points at one or more first times associated with the first path and one or more second interpolating points at one or more second times associated with the second path; setting one or more first barrier-value levels for the one or more first interpolating points based on at least information associated with a first precedence related to the first interpolating points; and setting one or more second barrier-value levels for the one or more second interpolating points based on at least information associated with a second precedence related to the second interpolating points. For example, the setting one or more first barrier-value levels for the one or more first interpolating points and setting one or more second barrier-value levels for the one or more second interpolating points includes: assigning one or more first numbers in a descending order to the first interpolating points based on at least information associated with the first time order; and assigning one or more second numbers in a descending order to the second interpolating points based on at least information associated with the second time order. The first barrier-value levels of the first object being higher than the second barrier-value levels of the second object in the overlap zone includes: the first numbers associated with the first object being larger than the second numbers associated with the second object in the overlap zone. In another example, the setting one or more first barrier-value levels for the one or more first interpolating points and setting one or more second barrier-value levels for the one or more second interpolating points includes: assigning one or more first numbers in an ascending order to the first interpolating points based on at least information associated with the first time order; and assigning one or more second numbers in an ascending order to the second interpolating points based on at least information associated with the second time order. The first barrier-value levels of the first object being higher than the second barrier-value levels of the second object in the overlap zone includes: the first numbers associated with the first object being smaller than the second numbers associated with the second object in the overlap zone.

According to another embodiment, the process 603 includes: in response to the first path overlapping with the second path in an overlap zone and the first barrier-value levels of the first object being higher than the second barrier-value levels of the second object in the overlap zone, recalculating a third path of the second object in the overlap zone and after the overlap zone. For example, if the first path overlaps with the second path in the overlap zone and the first barrier-value levels of the first object are higher than the second barrier-value levels of the second object in the overlap zone, the second object is blocked by the first object in the overlap zone which corresponds to a barrier zone. In another example, the process for recalculating the path of the second object corresponds to a path-recalculating process with the overlap zone as a barrier zone, e.g., using any suitable path-finding algorithms.

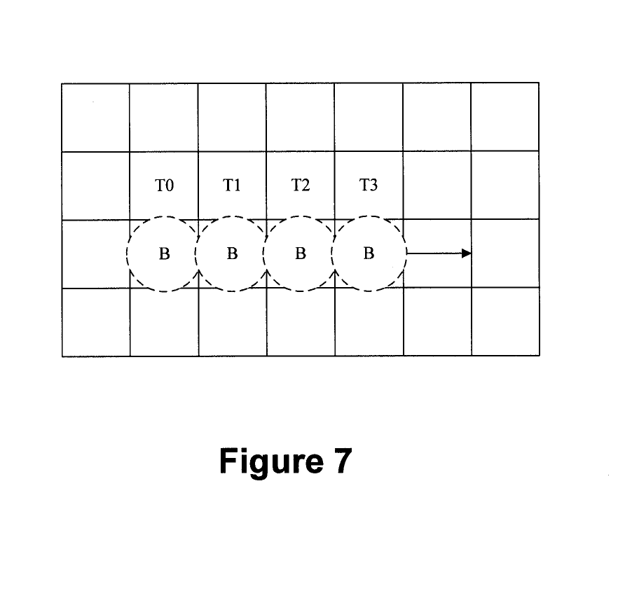

FIG. 7 is a simplified diagram showing different barrier-value levels for different interpolating points according to one embodiment of the present invention. This diagram is merely an example, which should not unduly limit the scope of the claims. One of ordinary skill in the art would recognize many variations, alternatives, and modifications.

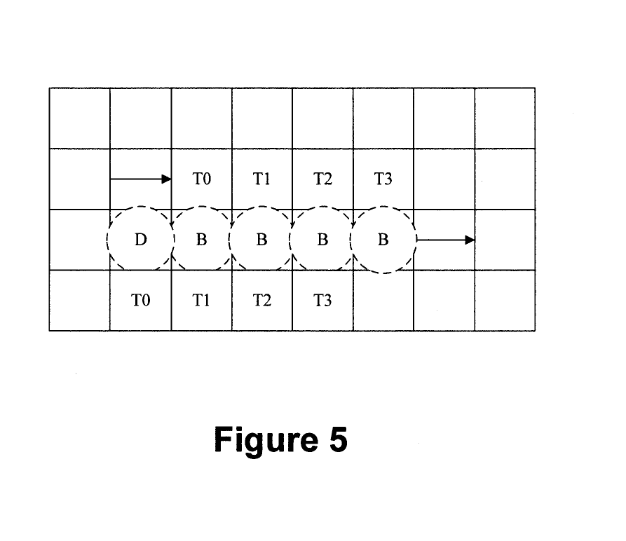

As shown in FIG. 7, a tick (e.g., 1/60 second) is divided into multiple time slices, in some embodiments. For example, the tick is associated with four barrier levels corresponding to T0-T3. The barrier-value levels of T0-T3 correspond to 0, 1, 2 and 3 respectively. As shown in FIG. 5, the object D behind the object B moves forward in a same tick. For example, a node A will be occupied by the object D as a 1-level barrier, and the node A already corresponds to a 0-level barrier. Because 1 is greater than 0, the barrier-value level of the node A is successfully reset to 1 for the object D, in some embodiments. For example, the object D follows immediately the object B to move, and the distance between the object D and the object B is not too long, so that a realistic simulation of object movements can be achieved.

According to one embodiment, in an online network game, B and D are two monsters, monster D behind monster B moves forward in a same tick. For example, a node A will be occupied by monster D as a 1-level barrier, and the node A already corresponds to a 0-level barrier. Because 1 is greater than 0, the barrier-value level of the node A is successfully reset to 1 for monster D, in some embodiments. For example, during a fighting scene, monster D follows immediately monster B to move, and the distance between monster D and monster B is not too long.

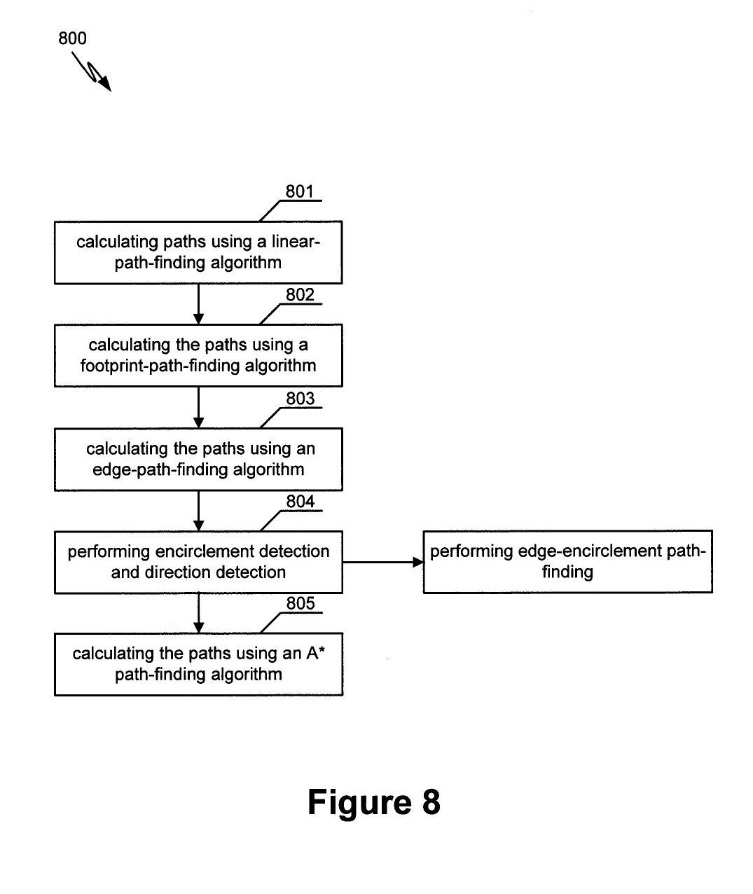

FIG. 8 is a simplified diagram showing a method for path finding according to one embodiment of the present invention. This diagram is merely an example, which should not unduly limit the scope of the claims. One of ordinary skill in the art would recognize many variations, alternatives, and modifications. The method 800 includes at least the processes 801-805.

According to one embodiment, the process 801 includes: calculating the first path and the second path using a linear-path-finding algorithm, and in response to failure of calculating the first path and the second path using the linear-path-finding algorithm or a first distance to a target position from the first object or the second object exceeding a predetermined value, executing the process 802. For example, the process 802 includes: calculating the first path and the second path using a footprint-path-finding algorithm, and in response to failure of calculating the first path and the second path using the footprint-path-finding algorithm, executing the process 803. In another example, the process 803 includes: calculating the first path and the second path using an edge-path-finding algorithm, and in response to failure of calculating the first path and the second path using the edge-path-finding algorithm, executing the process 804. In yet another example, the process 804 includes: performing encirclement detection and direction detection; in response to an encirclement being formed or a second distance being larger than a predetermined failure value, executing the process 805; and in response to the encirclement not being formed or the second distance being not larger than a predetermined failure value, performing edge-encirclement path-finding. In yet another example, the process 805 includes: calculating the first path and the second path using an A* path-finding algorithm.

According to another embodiment, the method 800 reduces reliance on and the use frequency of the A* path-finding algorithm which sometimes consumes a large amount of resources. For example, the footprint-path-finding algorithm is used for long-distance path finding, and the edge-path-finding algorithm is used for short-distance path finding. If both fail, the encirclement detection and the direction detection are performed to determine whether the A* path-finding algorithm is needed, in some embodiments. For example, failure of the A* path-finding algorithm which is very resource-consuming is to be avoided. As an example, a reasonable search depth is set for A*, and limit the use frequency of A* during each tick, so that the performance of path finding is controlled within an acceptable range to achieve a good running speed. Detailed description related to the edge-path-finding algorithm, the encirclement detection and the direction detection is provided herein.

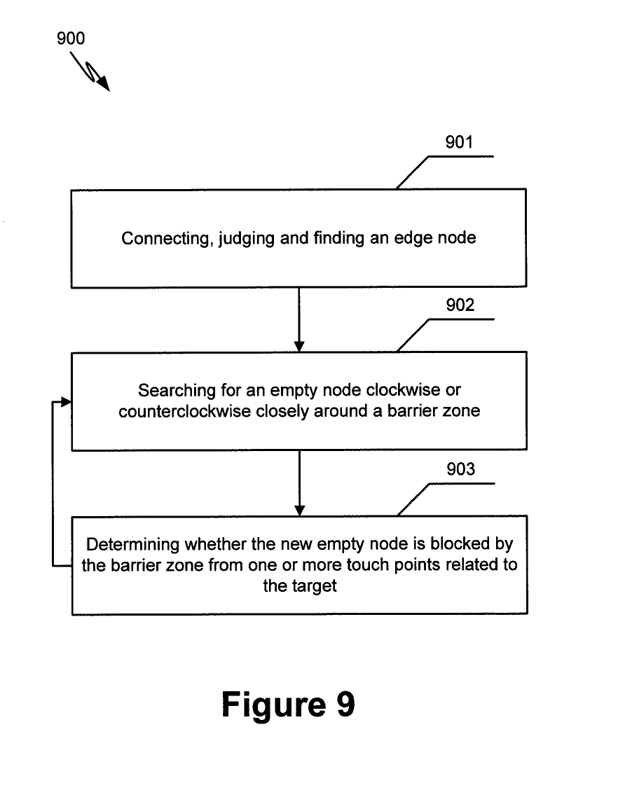

FIG. 9 is a simplified diagram showing a method using an edge-path-finding algorithm according to one embodiment of the present invention. This diagram is merely an example, which should not unduly limit the scope of the claims. One of ordinary skill in the art would recognize many variations, alternatives, and modifications.

Complexity of the method 900 is linear, and the method 900 performs well for path finding involving multiple objects, in some embodiments. For example, a shape of a barrier is irregular, and an alternative path selected around the barrier may become farther and farther. As an example, a deviation value is controlled to ensure the moving direction is roughly consistent toward a target position. In another example, in an online network game, after the edge-path-finding is performed, monsters or players move closely around a barrier and then move toward a target position. Specifically, the method 900 includes at least the processes 901-903. According to one embodiment, the process 901 includes: connecting, judging and finding an edge node. For example, the process 902 includes: searching for an empty node clockwise or counterclockwise closely around a barrier zone.

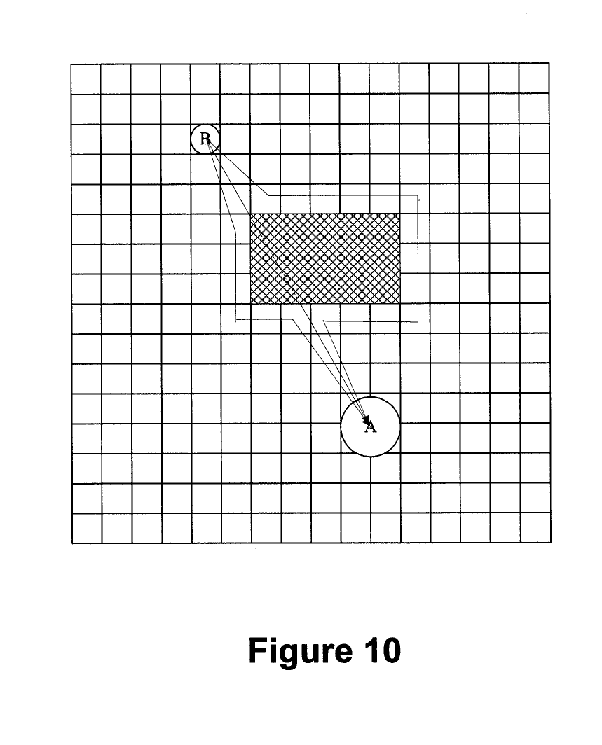

FIG. 10 is a simplified diagram showing different searching directions of the process 902 according to one embodiment of the present invention. This diagram is merely an example, which should not unduly limit the scope of the claims. One of ordinary skill in the art would recognize many variations, alternatives, and modifications. As shown in FIG. 10, the arrows indicate two directions of different paths, where B is a moving object and A corresponds to a target position, in some embodiments.

Referring back to FIG. 9, the process 903 includes: determining whether the new empty node is blocked by the barrier zone, in certain embodiments. For example, if the new empty node is blocked by the barrier zone from one or more touch points related to the target, the empty node is determined as a node on the calculated path, and the process 902 is executed. Otherwise, the process 903 is executed again and again till a line between the object and the target position is connected.

When the quantity of on-screen objects reaches a certain threshold, the encirclement detection and the direction detection are used to avoid the failure of A*, in some embodiments. For example, in an online network game, when the number of on-screen monsters reaches a certain threshold, the encirclement detection and the direction detection are used to avoid the failure of A*. As an example, a current node of an object is taken as a start point for path finding. In another example, nodes around the current node are operated with recursion using an arithmetic logic for filling closed picture in graphics. In yet another example, if a predetermined number of nodes are connected mutually, it is determined that the object is not encircled. Otherwise, the object is encircled, and the object is blocked from all around, which indicates that the A* path-finding algorithm should not be used. For example, the predetermined number of nodes include ten nodes. In certain embodiment, the encirclement detection is used in a network game, and when a monster or a player is blocked from all around, the A* path-finding algorithm is abandoned.

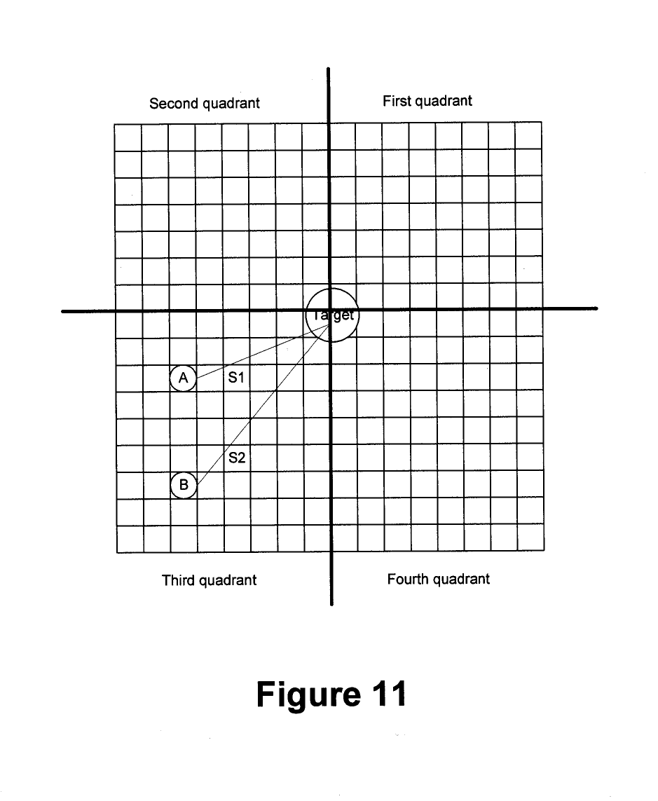

FIG. 11 is a simplified diagram showing direction detection according to one embodiment of the present invention. This diagram is merely an example, which should not unduly limit the scope of the claims. One of ordinary skill in the art would recognize many variations, alternatives, and modifications.

According to one embodiment, space around a target position is divided using two central cross lines into four zones, i.e., four quadrants with the target position as a center, and the four quadrants are marked as “first quadrant”-“fourth quadrant.” For example, object A uses the A* path-finding algorithm for path finding. In another example, if the A* path-finding algorithm fails, a distance S1 between the object A and the target position is set as a shortest failure distance of the A* path-finding algorithm in the “third quadrant.” In yet another example, if object B in a same tick starts path-finding to the target position, a distance S2 to the target position is calculated, and the shortest failure distance (S1) of the current node is found. If S2 is greater than the shortest failure distance S1, the A* path-finding algorithm is abandoned, in some embodiments. To make judgment more accurate, the four quadrants can be divided into eight quadrants, in certain embodiments.

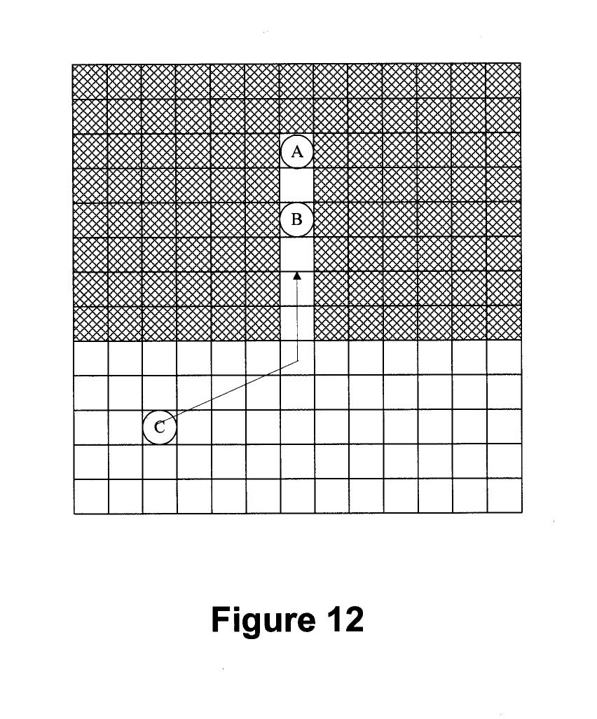

FIGS. 12-14 are simplified diagrams showing certain error corrections in path finding according to some embodiments of the present invention. The diagrams are merely examples, which should not unduly limit the scope of the claims. One of ordinary skill in the art would recognize many variations, alternatives, and modifications.

As shown in FIG. 12, a scene includes a bridge or other narrow terrains, in some embodiments. For example, objects A and B are in a narrow terrain and the object C is beyond the narrow terrain. As an example, if the position of object A is the target position, the object C cannot find a path to the target position because the object B becomes a barrier. Considering the A* path-finding algorithm can traverse surrounding nodes and evaluate the paths from every node to the target position, a shortest path (e.g., the arrow indicating the direction of the path) close to the target position is found during the execution of the A* path-finding algorithm, but the shortest path is not recorded. In some embodiments, the A* path-finding algorithm is modified to include recording the shortest evaluated path (even though not a successful path) in the path-finding process when the A* path-finding algorithm fails and returning such shortest evaluated path. The object C can move along the shortest path toward the target position to be close to the object A when the path-finding process fails, in certain embodiments. For example, in an online network game, monsters A and B are in a narrow terrain and the monster C is beyond the narrow terrain. At that moment, the position of monster A is the target position. Monster C blocked by monster B cannot find a path to the target position. The modified A* path-finding algorithm enables recording the shortest evaluated path when the A* path-finding algorithm fails and returning the shortest path, so that the monster C can move along the shortest path toward the target position to be close to monster A, in some embodiments.

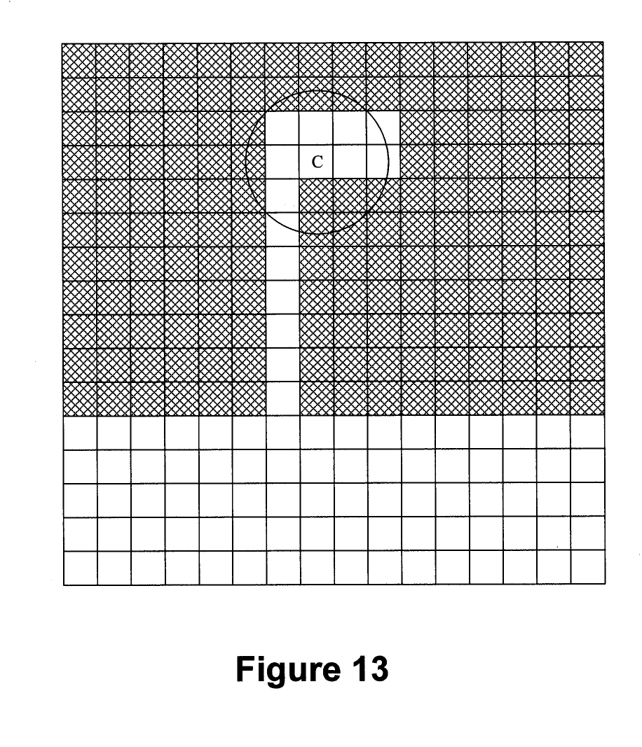

As shown in FIG. 13, nodes filled with black slanted lines correspond to static terrain barriers, in some embodiments. For example, the object C that occupies a large area is stuck because of the barriers. Multiple approaches may be considered to move the object C out. For example, one approach includes determining whether the object is stuck, and determining whether the object is going to move out of the barriers (e.g., considering how many barrier nodes are covered by the area of the object, whether at a next spot the object covers fewer barrier nodes than the preceding spot, etc.). In another example, the preferred approach includes: performing path finding considering the object having a size of 1×1 if the space occupied by the object includes a node overlapping with a static barrier, until the object stops being stuck (e.g., the space occupied by the object including no node overlapping with the static barrier). In yet another example, in an online network game, large-size monster C is stuck by a static terrain barrier. For example, monster C that occupies a large area is stuck because of the barriers. Multiple approaches may be considered to move monster C out. For example, one approach includes determining whether monster C is stuck, and determining whether monster C is going to move out of the barriers (e.g., considering how many barrier nodes are covered by the area of monster C, whether at a next spot monster C covers fewer barrier nodes than the preceding spot, etc.). In another example, the preferred approach includes: performing path finding considering monster C having a size of 1×1 if the space occupied by monster C includes a node overlapping with a static barrier until monster C stops being stuck (e.g., the space occupied by monster C including no node overlapping with the static barrier).

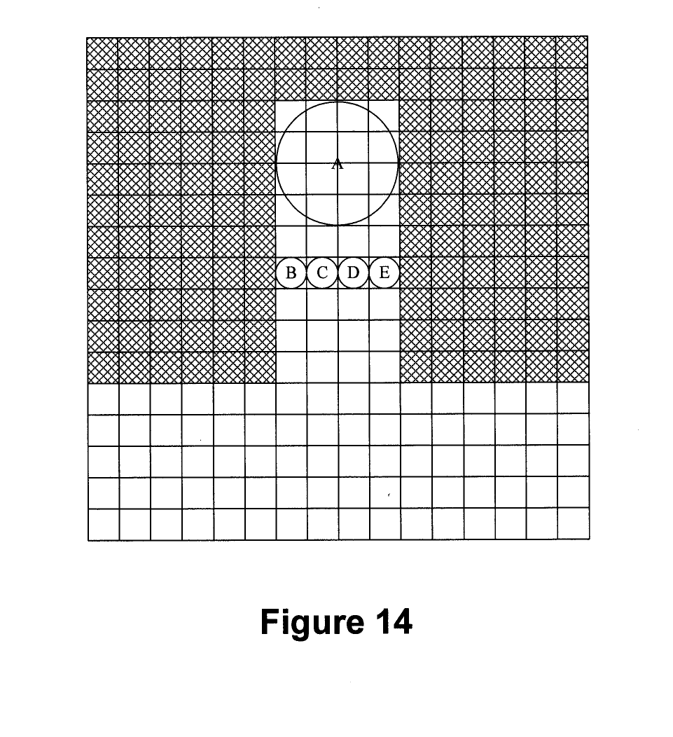

As shown in FIG. 14, object A with a high priority is stuck due to objects B, C, D, and E with lower priorities, in some embodiments. For example, one approach is based on priorities and includes objects with low priorities yield to objects with high priorities. In another example, a preferred approach includes the following: when low-priority objects move, barriers associated with a high-priority object A need to be considered, while barriers of other objects are not considered when the object A moves. That is, the high-priority object A can pass through the low-priority objects. Usually, high-priority objects that have large sizes appear to cross over smaller low-priority objects when passing through them, which does not affect visual simulations that much. For example, in an online network game, monster A with a high priority (such as a BOSS monster) is stuck due to monsters B, C, D, and E with low priorities (such as small monsters). The small monsters keep shooting the player who is shooting BOSS. But BOSS that often fights in a short range is blocked by small monsters and cannot move out. For example, one approach is based on priorities and includes objects with low priorities yield to objects with high priorities. In another example, a preferred approach includes the following: when low-priority small monsters move, barriers associated with the high-priority BOSS need to be considered, while barriers of small monsters are not considered when BOSS moves. That is, BOSS can pass through the small monsters. Usually, BOSS that has a large size appears to cross over small monsters when passing through them, which does not affect visual simulations that much.

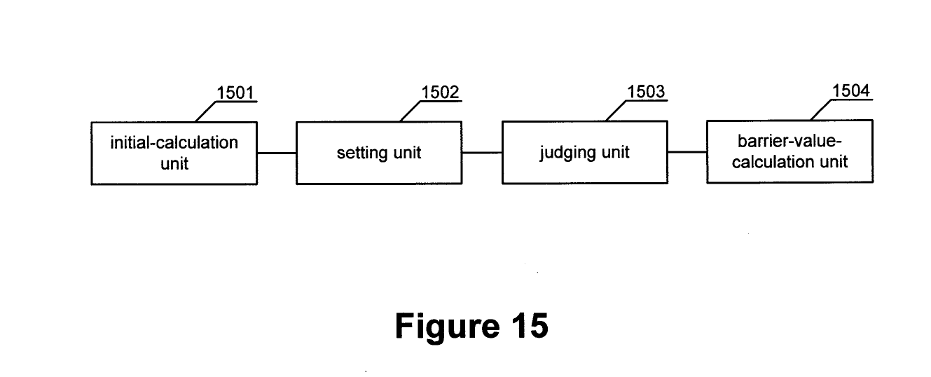

FIG. 15 is a simplified diagram showing a device for path finding according to one embodiment of the present invention. This diagram is merely an example, which should not unduly limit the scope of the claims. One of ordinary skill in the art would recognize many variations, alternatives, and modifications. The device 1500 includes an initial-calculation unit 1501, a setting unit 1502, a judging unit 1503, and a barrier-value-calculation unit 1504.

According to one embodiment, the initial-calculation unit 1501 is configured to calculate a first path of a first object and a second path of a second object during a predetermined time period. For example, the setting unit 1502 is configured to set one or more first interpolating points at one or more first times associated with the first path and one or more second interpolating points at one or more second times associated with the second path, set one or more first barrier-value levels for the one or more first interpolating points based on at least information associated with a first precedence related to the first interpolating points, and set one or more second barrier-value levels for the one or more second interpolating points based on at least information associated with a second precedence related to the second interpolating points. In another example, the judging unit 1503 is configured to determine whether the first path overlaps with the second path and determine, in response to the first path overlapping with the second path in an overlap zone, whether the first barrier-value levels of the first object are higher than the second barrier-value levels of the second object in the overlap zone. In yet another example, the barrier-value-calculation unit 1504 is configured to, in response to the first path overlapping with the second path in an overlap zone and the first barrier-value levels of the first object being higher than the second barrier-value levels of the second object in the overlap zone, recalculate a third path of the second object in the overlap zone and after the overlap zone. For example, if the first path overlaps with the second path in the overlap zone and the first barrier-value levels of the first object are higher than the second barrier-value levels of the second object in the overlap zone, the second object is blocked by the first object in the overlap zone which corresponds to a barrier zone. In another example, the process for recalculating the path of the second object corresponds to a path-recalculating process with the overlap zone as a barrier zone, e.g., using any suitable path-finding algorithms.

As shown in FIG. 7, a tick (e.g., 1/60 second) is divided into multiple time slices, in some embodiments. For example, the tick is associated with four barrier levels corresponding to T0-T3. The barrier-value levels of T0-T3 correspond to 0, 1, 2 and 3 respectively. As shown in FIG. 5, the object D behind the object B moves forward in a same tick. For example, a node A will be occupied by the object D as a 1-level barrier, and the node A already corresponds to a 0-level barrier. Because 1 is greater than 0, the barrier-value level of the node A is successfully reset to 1 for the object D, in some embodiments. For example, the object D follows immediately the object B to move, and the distance between the object D and the object B is not too long, so that a realistic simulation of object movements can be achieved.

According to one embodiment, in an online network game, B and D are two monsters, monster D behind monster B moves forward in a same tick. For example, a node A will be occupied by monster D as a 1-level barrier, and the node A already corresponds to a 0-level barrier. Because 1 is greater than 0, the barrier-value level of the node A is successfully reset to 1 for monster D, in some embodiments. For example, during a fighting scene, monster D follows immediately monster B to move, and the distance between monster D and monster B is not too long.

According to another embodiment, the setting unit 1502 is further configured to assign one or more first numbers in a descending order to the first interpolating points based on at least information associated with the first time order and assign one or more second numbers in a descending order to the second interpolating points based on at least information associated with the second time order. For example, the judging unit 1503 is further configured to determine whether the first numbers associated with the first object are larger than the second numbers associated with the second object in the overlap zone.

According to another embodiment, the setting unit 1502 is further configured to assign one or more first numbers in a ascending order to the first interpolating points based on at least information associated with the first time order and assign one or more second numbers in a ascending order to the second interpolating points based on at least information associated with the second time order. For example, the judging unit 1503 is further configured to determine whether the first numbers associated with the first object are smaller than the second numbers associated with the second object in the overlap zone.

In one embodiment, the initial-calculation unit 1501 is further configured to: calculate the first path and the second path using a linear-path-finding algorithm; in response to failure of calculating the first path and the second path using the linear-path-finding algorithm or a first distance to a target position from the first object or the second object exceeding a predetermined value, calculate the first path and the second path using a footprint-path-finding algorithm; in response to failure of calculating the first path and the second path using the footprint-path-finding algorithm, calculate the first path and the second path using an edge-path-finding algorithm. For example, the initial-calculation unit 1501 is further configured to, in response to failure of calculating the first path and the second path using the edge-path-finding algorithm, perform encirclement detection and direction detection; in response to an encirclement being formed or a second distance being larger than a predetermined failure value, calculate the first path and the second path using an A* path-finding algorithm; and in response to the encirclement not being formed or the second distance being not larger than a predetermined failure value, perform edge-encirclement path-finding.

In another embodiment, the initial-calculation unit 1501 is further configured to, in response to failure of calculating the first path of the first object and the second path of the second object during the predetermined time period, choose a third path as the first path or the second path from one or more failed paths calculated using an A* path-finding algorithm for the first object or the second object during the predetermined time period, the third path being shortest among the failed paths. For example, the initial-calculation unit 1501 is further configured to, in response to failure of calculating the first path of the first object and the second path of the second object during the predetermined time period, determine whether the first object or the second object overlaps with a static barrier; and in response to the first object overlapping with the static barrier, set a first size of the first object to a minimum calculable size; and in response to the second object overlapping with the static barrier, set a second size of the second object to the minimum calculable size. In another example, the initial-calculation unit 1501 is further configured to, in response to failure of calculating the first path of the first object and the second path of the second object during the predetermined time period, determine a first priority of the first object and a second priority of the second object; in response to the first priority being higher than the second priority and the first object being blocked by the second object, ignore the second barrier-value levels; and in response to the second priority being higher than the first priority and the second object being blocked by the first object, ignore the first barrier-value levels. In yet another example, the initial-calculation unit 1501 is further configured to: determine a first priority of the first object and a second priority of the second object; in response to the first priority being higher than the second priority, increase a third priority of the first object for calculating the first path; and in response to the second priority being higher than the first priority, increase a fourth priority of the second object for calculating the second path.

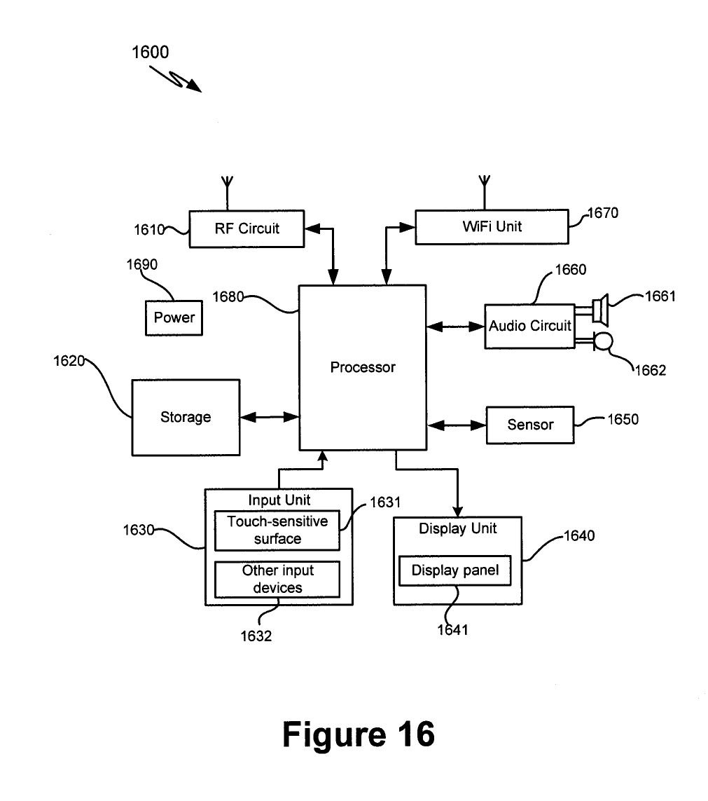

FIG. 16 is a simplified diagram showing a terminal for path finding according to one embodiment of the present invention. The diagram is merely an example, which should not unduly limit the scope of the claims. One of ordinary skill in the art would recognize many variations, alternatives, and modifications. For example, the terminal 1600 includes a mobile phone, a tablet PC, a PDA (Personal Digital Assistant), a POS (Point of Sales terminal), a car computer or any terminal equipment.

According to one embodiment, the terminal 1600 (e.g., a mobile phone) includes a RF (i.e., radio frequency) circuit 1610, a memory 1620 that includes one or more computer-readable storage medium, an input unit 1630, a display unit 1640, a sensor 1650, an audio circuit 1660, a WiFi (i.e., wireless fidelity) module 1670, one or more processors 1680 that includes one or more processing cores, and a power supply 890. For example, the RF circuit 1610 is configured to send/receive messages or signals in communication. As an example, the RF circuit 1610 receives a base station's downlink information, delivers to the processors 1680 for processing, and sends uplink data to the base station. For example, the RF circuit 1610 includes an antenna, at least one amplifier, a tuner, one or several oscillators, SIM (Subscriber Identity Module) card, a transceiver, a coupler, an LNA (Low Noise Amplifier) and a duplexer. In another example, the RF circuit 1610 communicates with the network and other equipments via wireless communication based on any communication standard or protocols, such as GSM (Global System of Mobile communication), GPRS (General Packet Radio Service), CDMA (Code Division Multiple Access), WCDMA (Wideband Code Division Multiple Access), LTE (Long Term Evolution), email, SMS (Short Messaging Service), etc.

According to another embodiment, the memory 1620 is configured to store software programs and modules. For example, the processors 1680 are configured to execute various functional applications and data processing by running the software programs and modules stored in the memory 1620. The memory 1620 includes a program storage area and a data storage area, where the program storage area may store the operating system, and the application(s) required by one or more functions (e.g., an audio player or a video player), in some embodiments. For example, the data storage area stores the data created based on the use of the terminal 1600 (e.g., audio data or a phone book). In another example, the memory 1620 includes a high-speed random access storage, a non-volatile memory, one or more floppy disc storage devices, a flash storage device or other volatile solid storage devices. As an example, the memory 1620 further includes a memory controller to enable access to the memory 1620 by the processors 1680 and the input unit 1630.

According to yet another embodiment, the input unit 1630 is configured to receive an input number or character data and generate inputs for a keyboard, a mouse, and a joystick, optical or track signals relating to user setting and functional control. For example, the input unit 1630 includes a touch-sensitive surface 1631 and other input devices 1632. The touch-sensitive surface 1631 (e.g., a touch screen or a touch panel) is configured to receive the user's touch operations thereon or nearby (e.g., the user's operations on or near the touch-sensitive surface with a finger, a touch pen or any other appropriate object or attachment) and drive the corresponding connected devices according to the predetermined program. For example, the touch-sensitive surface 1631 includes two parts, namely a touch detector and a touch controller. The touch detector detects the position of user touch and the signals arising from such touches and sends the signals to the touch controller. The touch controller receives touch data from the touch detector, converts the touch data into the coordinates of the touch point, sends the coordinates to the processors 1680 and receives and executes the commands received from the processors 1680. For example, the touch-sensitive surface 1631 is of a resistance type, a capacitance type, an infrared type and a surface acoustic wave type. In another example, other than the touch-sensitive surface, the input unit 1630 includes the other input devices 1632. For example, the other input devices 1632 include one or more physical keyboards, one or more functional keys (e.g., size control keys or switch keys), a track ball, a mouse and/or a joystick.

According to yet another embodiment, the display unit 1640 is configured to display data input from a user or provided to the user, and includes various graphical user interfaces of the terminal 1600. For example, these graphical user interfaces include menus, graphs, texts, icons, videos and a combination thereof. The display unit 1640 includes a display panel 1641 which contains a LCD (liquid crystal display), an OLED (organic light-emitting diode). As an example, the touch-sensitive surface can cover the display panel 1641. For example, upon detecting any touch operations thereon or nearby, the touch-sensitive surface sends signals to the processors 1680 to determine the type of the touch events and then the processors 1680 provides corresponding visual outputs on the display panel 1641 according to the type of the touch events. Although the touch-sensitive surface 1631 and the display panel 1641 are two independent parts for input and output respectively, the touch-sensitive surface 1631 and the display panel 1641 can be integrated for input and output, in some embodiments.

In one embodiment, the terminal 1600 includes a sensor 1650 (e.g., an optical sensor, a motion sensor or other sensors). For example, the sensor 1650 includes an environment optical sensor and adjusts the brightness of the display panel 1641 according to the environmental luminance. In another example, the sensor 1650 includes a proximity sensor and turns off or backlights the display panel when the terminal 1600 moves close to an ear of a user. In yet another example, the sensor 1650 includes a motion sensor (e.g., a gravity acceleration sensor) and detects a magnitude of acceleration in all directions (e.g., three axes). Particularly, the sensor 1650 detects a magnitude and a direction of gravity when staying still. In some embodiments, the sensor 1650 is used for identifying movements of a cell phone (e.g., a switch of screen direction between horizontal and vertical, related games, and a calibration related to a magnetometer) and features related to vibration identification (e.g., a pedometer or a strike). In certain embodiments, the sensor 1650 includes a gyroscope, a barometer, a hygroscope, a thermometer and/or an infrared sensor.

In another embodiment, the audio circuit 1660, a speaker 1661, and a microphone 1662 are configured to provide an audio interface between a user and the terminal 1600. For example, the audio circuit 1660 is configured to transmit electrical signals converted from certain audio data to the speaker that converts such electrical signals into some output audio signals. In another example, the microphone is configured to convert audio signals into electrical signals which are converted into audio data by the audio circuit 1660. The audio data are processed in the processors 1680 and received by the RF circuit 1610 before being sent to another terminal, in some embodiments. For example, the audio data are output to the memory 1620 for further processing. As an example, the audio circuit 1660 includes an earphone jack for communication between a peripheral earphone and the terminal 1600.

WiFi is a short-distance wireless transmission technology. In some embodiments, through the WiFi module 1670, the terminal 1600 enables the user to receive and send emails, browse webpages, and/or access stream media. For example, the terminal 1600 is configured to provide the user with a wireless broadband Internet access. In some embodiments, the WiFi module 1670 is omitted in the terminal 1600.

According to one embodiment, the processors 1680 are the control center of the terminal 1600. For example, the processors 1680 is connected to various parts of the terminal 1600 (e.g., a cell phone) via various interfaces and circuits, and executes various features of the terminal 1600 and processes various data through operating or executing the software programs and/or modules stored in the memory 1620 and calling the data stored in the memory 1620, so as to monitor and control the terminal 1600 (e.g., a cell phone). As an example, the processors 1680 include one or more processing cores. In another example, the processors 1680 is integrated with an application processor and a modem processor, where the application processor mainly handles the operating system, the user interface and the applications and the modem processor mainly handles wireless communications. In some embodiments, the modem processor is not integrated into the processors 1680.

According to another embodiment, the terminal 1600 includes the power supply 890 (e.g., a battery) that powers up various parts. For example, the power supply 890 is logically connected to the processors 1680 via a power source management system so that the charging, discharging and power consumption can be managed via the power source management system. In another example, the power supply 890 includes one or more DC or AC power sources, a recharging system, a power-failure-detection circuit, a power converter, an inverter, a power source state indicator, or other components. In yet another example, the terminal 1600 includes a camcorder, a Bluetooth module, etc. Specifically, the processors 1680 of the terminal 1600 load executable files associated with one or more applications to the memory 1620 and run the applications stored in the memory 1620 according to the method 600, the method 800, and/or the method 900.

According to one embodiment, a method is provided for path finding. For example, a first path of a first object and a second path of a second object are calculated during a predetermined time period; one or more first interpolating points are set at one or more first times associated with the first path and one or more second interpolating points are set at one or more second times associated with the second path; one or more first barrier-value levels are set for the one or more first interpolating points based on at least information associated with a first precedence related to the first interpolating points; one or more second barrier-value levels are set for the one or more second interpolating points based on at least information associated with a second precedence related to the second interpolating points; and in response to the first path overlapping with the second path in an overlap zone and the first barrier-value levels of the first object being higher than the second barrier-value levels of the second object in the overlap zone, a third path of the second object is recalculated in the overlap zone and after the overlap zone. For example, the method is implemented according to at least FIG. 6, FIG. 8, and/or FIG. 9.

According to another embodiment, a device for path finding includes: an initial-calculation unit, a setting unit, a judging unit, and a barrier-value-calculation unit. The initial-calculation unit is configured to calculate a first path of a first object and a second path of a second object during a predetermined time period. The setting unit is configured to set one or more first interpolating points at one or more first times associated with the first path and one or more second interpolating points at one or more second times associated with the second path, set one or more first barrier-value levels for the one or more first interpolating points based on at least information associated with a first precedence related to the first interpolating points, and set one or more second barrier-value levels for the one or more second interpolating points based on at least information associated with a second precedence related to the second interpolating points. The judging unit is configured to determine whether the first path overlaps with the second path and determine, in response to the first path overlapping with the second path in an overlap zone, whether the first barrier-value levels of the first object are higher than the second barrier-value levels of the second object in the overlap zone. The barrier-value-calculation unit is configured to, in response to the first path overlapping with the second path in an overlap zone and the first barrier-value levels of the first object being higher than the second barrier-value levels of the second object in the overlap zone, recalculate a third path of the second object in the overlap zone and after the overlap zone. For example, the device is implemented according to at least FIG. 15.

According to yet another embodiment, a non-transitory computer readable storage medium comprises programming instructions for path finding. The programming instructions are configured to cause one or more data processors to execute certain operations. For example, a first path of a first object and a second path of a second object are calculated during a predetermined time period; one or more first interpolating points are set at one or more first times associated with the first path and one or more second interpolating points are set at one or more second times associated with the second path; one or more first barrier-value levels are set for the one or more first interpolating points based on at least information associated with a first precedence related to the first interpolating points; one or more second barrier-value levels are set for the one or more second interpolating points based on at least information associated with a second precedence related to the second interpolating points; and in response to the first path overlapping with the second path in an overlap zone and the first barrier-value levels of the first object being higher than the second barrier-value levels of the second object in the overlap zone, a third path of the second object is recalculated in the overlap zone and after the overlap zone. For example, the storage medium is implemented according to at least FIG. 6, FIG. 8, and/or FIG. 9.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for path finding, comprising:
calculating a first path of a first object and a second path of a second object during a predetermined time period;
setting one or more first interpolating points at one or more first times associated with the first path and one or more second interpolating points at one or more second times associated with the second path;
setting one or more first barrier-value levels for the one or more first interpolating points based on at least information associated with a first precedence related to the first interpolating points;
setting one or more second barrier-value levels for the one or more second interpolating points based on at least information associated with a second precedence related to the second interpolating points; and
in response to the first path overlapping with the second path in an overlap zone and the first barrier-value levels of the first object being higher than the second barrier-value levels of the second object in the overlap zone, recalculating a third path of the second object in the overlap zone and after the overlap zone.

2. The method of claim 1, wherein:
the setting one or more first barrier-value levels for the one or more first interpolating points based on at least information associated with a first time order related to the first interpolating points and setting one or more second barrier-value levels for the one or more second interpolating points based on at least information associated with a second time order related to the second interpolating points includes:
assigning one or more first numbers in a descending order to the first interpolating points based on at least information associated with the first time order; and
assigning one or more second numbers in a descending order to the second interpolating points based on at least information associated with the second time order; and
the first barrier-value levels of the first object being higher than the second barrier-value levels of the second object in the overlap zone includes: the first numbers associated with the first object being larger than the second numbers associated with the second object in the overlap zone.

3. The method of claim 1, wherein:
the setting one or more first barrier-value levels for the one or more first interpolating points based on at least information associated with a first time order related to the first interpolating points and setting one or more second barrier-value levels for the one or more second interpolating points based on at least information associated with a second time order related to the second interpolating points includes:
assigning one or more first numbers in an ascending order to the first interpolating points based on at least information associated with the first time order; and
assigning one or more second numbers in an ascending order to the second interpolating points based on at least information associated with the second time order; and
the first barrier-value levels of the first object being higher than the second barrier-value levels of the second object in the overlap zone includes: the first numbers associated with the first object being smaller than the second numbers associated with the second object in the overlap zone.

4. The method of claim 1, wherein the calculating a first path of a first object and a second path of a second object during a predetermined time period includes:
calculating the first path and the second path using a linear-path-finding algorithm;
in response to failure of calculating the first path and the second path using the linear-path-finding algorithm or a first distance to a target position from the first object or the second object exceeding a predetermined value, calculating the first path and the second path using a footprint-path-finding algorithm;
in response to failure of calculating the first path and the second path using the footprint-path-finding algorithm, calculating the first path and the second path using an edge-path-finding algorithm; and
in response to failure of calculating the first path and the second path using the edge-path-finding algorithm,
performing encirclement detection and direction detection;
in response to an encirclement being formed or a second distance being larger than a predetermined failure value, calculating the first path and the second path using an A* path-finding algorithm; and
in response to the encirclement not being formed or the second distance being not larger than a predetermined failure value, performing edge-encirclement path-finding.

5. The method of claim 1, further comprising:
in response to failure of calculating the first path of the first object and the second path of the second object during the predetermined time period, choosing a third path as the first path or the second path from one or more failed paths calculated using an A* path-finding algorithm for the first object or the second object during the predetermined time period, the third path being shortest among the failed paths.

6. The method of claim 1, further comprising:
in response to failure of calculating the first path of the first object and the second path of the second object during the predetermined time period,
determining whether the first object or the second object overlaps with a static barrier; and
in response to the first object overlapping with the static barrier, setting a first size of the first object to a minimum calculable size; and
in response to the second object overlapping with the static barrier, setting a second size of the second object to the minimum calculable size.

7. The method of claim 1, further comprising:
in response to failure of calculating the first path of the first object and the second path of the second object during the predetermined time period,
determining a first priority of the first object and a second priority of the second object;
in response to the first priority being higher than the second priority and the first object being blocked by the second object, ignoring the second barrier-value levels; and
in response to the second priority being higher than the first priority and the second object being blocked by the first object, ignoring the first barrier-value levels.

8. The method of claim 1, further comprising:
determining a first priority of the first object and a second priority of the second object;
in response to the first priority being higher than the second priority, increasing a third priority of the first object for calculating the first path; and
in response to the second priority being higher than the first priority, increasing a fourth priority of the second object for calculating the second path.

9. A device for path finding, comprising:
an initial-calculation unit configured to calculate a first path of a first object and a second path of a second object during a predetermined time period;
a setting unit configured to set one or more first interpolating points at one or more first times associated with the first path and one or more second interpolating points at one or more second times associated with the second path, set one or more first barrier-value levels for the one or more first interpolating points based on at least information associated with a first precedence related to the first interpolating points, and set one or more second barrier-value levels for the one or more second interpolating points based on at least information associated with a second precedence related to the second interpolating points;
a judging unit configured to determine whether the first path overlaps with the second path and determine, in response to the first path overlapping with the second path in an overlap zone, whether the first barrier-value levels of the first object are higher than the second barrier-value levels of the second object in the overlap zone; and
a barrier-value-calculation unit configured to, in response to the first path overlapping with the second path in an overlap zone and the first barrier-value levels of the first object being higher than the second barrier-value levels of the second object in the overlap zone, recalculate a third path of the second object in the overlap zone and after the overlap zone.

10. The device of claim 9, wherein:
the setting unit is further configured to assign one or more first numbers in a descending order to the first interpolating points based on at least information associated with the first time order and assign one or more second numbers in a descending order to the second interpolating points based on at least information associated with the second time order; and
the judging unit is further configured to determine whether the first numbers associated with the first object are larger than the second numbers associated with the second object in the overlap zone.

11. The device of claim 9, wherein:
the setting unit is further configured to assign one or more first numbers in a ascending order to the first interpolating points based on at least information associated with the first time order and assign one or more second numbers in a ascending order to the second interpolating points based on at least information associated with the second time order; and
the judging unit is further configured to determine whether the first numbers associated with the first object are smaller than the second numbers associated with the second object in the overlap zone.

12. The device of claim 9, wherein the initial-calculation unit is further configured to:
calculate the first path and the second path using a linear-path-finding algorithm;
in response to failure of calculating the first path and the second path using the linear-path-finding algorithm or a first distance to a target position from the first object or the second object exceeding a predetermined value, calculate the first path and the second path using a footprint-path-finding algorithm;
in response to failure of calculating the first path and the second path using the footprint-path-finding algorithm, calculate the first path and the second path using an edge-path-finding algorithm; and
in response to failure of calculating the first path and the second path using the edge-path-finding algorithm,
perform encirclement detection and direction detection;
in response to an encirclement being formed or a second distance being larger than a predetermined failure value, calculate the first path and the second path using an A* path-finding algorithm; and
in response to the encirclement not being formed or the second distance being not larger than a predetermined failure value, perform edge-encirclement path-finding.

13. The device of claim 9, wherein the initial-calculation unit is further configured to, in response to failure of calculating the first path of the first object and the second path of the second object during the predetermined time period, choose a third path as the first path or the second path from one or more failed paths calculated using an A* path-finding algorithm for the first object or the second object during the predetermined time period, the third path being shortest among the failed paths.

14. The device of claim 9, wherein the initial-calculation unit is further configured to, in response to failure of calculating the first path of the first object and the second path of the second object during the predetermined time period,
determine whether the first object or the second object overlaps with a static barrier; and
in response to the first object overlapping with the static bather, set a first size of the first object to a minimum calculable size; and
in response to the second object overlapping with the static barrier, set a second size of the second object to the minimum calculable size.

15. The device of claim 9, wherein the initial-calculation unit is further configured to, in response to failure of calculating the first path of the first object and the second path of the second object during the predetermined time period,
determine a first priority of the first object and a second priority of the second object;
in response to the first priority being higher than the second priority and the first object being blocked by the second object, ignore the second barrier-value levels; and
in response to the second priority being higher than the first priority and the second object being blocked by the first object, ignore the first barrier-value levels.

16. The device of claim 9, wherein the initial-calculation unit is further configured to:
determine a first priority of the first object and a second priority of the second object;
in response to the first priority being higher than the second priority, increase a third priority of the first object for calculating the first path; and
in response to the second priority being higher than the first priority, increase a fourth priority of the second object for calculating the second path.

17. The device of claim 9, further comprising:
one or more data processors; and
a computer-readable storage medium;
wherein one or more of the initial-calculation unit, the setting unit, the judging unit, and the barrier-value-calculation unit are stored in the storage medium and configured to be executed by the one or more data processors.

18. A non-transitory computer readable storage medium comprising programming instructions for path finding, the programming instructions configured to cause one or more data processors to execute operations comprising:
calculating a first path of a first object and a second path of a second object during a predetermined time period;
setting one or more first interpolating points at one or more first times associated with the first path and one or more second interpolating points at one or more second times associated with the second path;
setting one or more first barrier-value levels for the one or more first interpolating points based on at least information associated with a first precedence related to the first interpolating points;
setting one or more second barrier-value levels for the one or more second interpolating points based on at least information associated with a second precedence related to the second interpolating points; and
in response to the first path overlapping with the second path in an overlap zone and the first barrier-value levels of the first object being higher than the second barrier-value levels of the second object in the overlap zone, recalculating a third path of the second object in the overlap zone and after the overlap zone.
